(19) United States
(12) Patent Application Publication
(10) Pub. No.: US 2006/0126186 A1
(43) Pub. Date: Jun. 15, 2006

(54) Lenticular lens sheet, rear projection type screen, and rear projection type projector, and lenticular lens sheet producing method

(75) Inventors: Tsuyoshi Kanda, Niigata (JP); Toyohide Sonoda, Niigata (JP); Youji Ono, Niigata (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Co., Ltd., Okayama (JP)

(21) Appl. No.: 10/542,877

(22) PCT Filed: Jan. 22, 2004
(86) PCT No.: PCT/JP04/00526

§ 371 Date: Jul. 20, 2005

(30) Foreign Application Priority Data
Jan. 23, 2003 (JP) 2003-014380

(51) Int. Cl. G02B 27/10

(52) U.S. Cl. 359/622

(57) ABSTRACT

The rear projection screen of the present invention has a lenticular lens sheet 1. In the input surface of the lenticular lens sheet 1, a first lens array 12 is formed on a first lens layer 14. In the boundary between the first lens layer 14 and a second lens layer 15, a second lens array 13 substantially orthogonal to the first lens array 12 is formed. The second lens layer 15 has a different refractive index from the first lens layer 14. A lattice-shaped or stripe-shaped self-aligned ambient light absorbing layer 17 is formed in a light non-passing position on the second lens layer 15.

### TECHNICAL FIELD

The present invention relates to a lenticular lens sheet, a rear projection screen, a rear projection apparatus, and a method of manufacturing a lenticular lens sheet.

### BACKGROUND ART

A rear projection screen used in a rear projection apparatus or the like normally has a structure where two lens sheets are placed on top of each other. Specifically, a Fresnel lens sheet which narrows down the video light from a rear projection projector within a certain angle range are placed in light source side, and a lenticular lens sheet which has a function to spread the video light transmitted through the Fresnel lens sheet over an appropriate angle range is placed in observer side.

Particularly, very fine and high quality rear projection liquid crystal projection television requires a lens sheet with fine pitch of 0.3 mm or smaller. The structure of such a lens sheet is disclosed in Japanese Unexamined Patent Publication No. 09-120101, for example. FIG. 16 shows a structure of the lens sheet disclosed.

In FIG. 16, reference symbol 1 designates a lenticular lens sheet, which is composed of a transparent base 3 and a lens 2 in this example. In the output surface side of the lenticular lens sheet 1, an ambient light absorbing layer 4 is placed in the light non-focus positions where light does not passes through of the lenticular lens. Placing the ambient light absorbing layer 4 reduces the ambient light which comes into the lenticular lens sheet 1 from the output surface side or observer side and is reflected by the lenticular lens sheet 1 to return to the observer side, thereby improving image contrast.

The lenticular lens sheet 1 is also provided with a transparent resin film 6 with a diffusion layer 5 interposed therebetween. The transparent resin film 6 is disclosed in Japanese Unexamined Patent Publication No. 08-22077 and 07-307912, for example. The transparent resin film 6 is placed in order to protect the lenticular lens sheet, to obtain surface glaze similar to a normal cathode-ray tube television, and so on.

Besides, though not shown in FIG. 16, a Fresnel lens sheet is normally placed in the input surface side of the lenticular lens sheet 1. The Fresnel lens sheet is a sheet with Fresnel lens composed of fine pitch lenses arranged concentrically at regular intervals is formed in the light output surface.

In the lens sheet having the above structure, while the viewing angle performance in the horizontal direction is obtained mainly by diffusion with an incident lens, the diffusion performance in the vertical direction is achieved only by the diffusion layer 5. Thus, diffusion material used to obtain the required vertical viewing angle causes reflection loss of input light, which poses a fundamental limitation to obtain a high brightness screen and makes images out of focus. Further, since the diffusion layer 5 covers the ambient light absorbing layer 4, ambient light absorption efficiency decreases to lower the contrast. Furthermore, the ambient light absorbing layer 4 is fundamentally restricted to the form of stripe, which poses a limitation to an obtained black area ratio.

Also proposed is a three-dimensional lens array sheet for a projection screen, which has convex three-dimensional lenses arranged on the input surface and a lattice-shaped light shielding pattern formed in the position corresponding to a non-focus part of each lens on the other side surface, on which pattern a transparent base or a base having a diffusion layer is formed.

If this sheet is realized, the contrast is improved significantly since the light shielding pattern can be formed in a lattice shape and the diffusion layer can be eliminated or minimized. However, manufacture of the fine three-dimensional lens array sheet requires a highly accurate and large-scale mold, and it is extremely difficult to produce such a mold; therefore, this sheet has not been realized yet.

In order to overcome these drawbacks, the structure where lenticular lenses are arranged on both input and output surfaces of a lenticular lens sheet so that they are orthogonal to each other is proposed (for example, Japanese Unexamined Patent Publication No. 50-10134). This structure also has an ambient light absorbing layer or a light-shielding pattern to increase contrasts. The conventional technique places the ambient light absorbing layer in a separate sheet from the lenticular lens sheet.

However, if the ambient light absorbing layer is formed in a different sheet from the lenticular lens sheet, the relative position of the sheets along surface can deviate, and it is extremely difficult to arrange the ambient light absorbing layer accurately in the non-passing position of the lenticular lens. Further, this structure has a problem that the interval between the sheets varies by temperature or humidity change and a lens focus position thereby deviates, which reduces the area of the ambient light absorbing layer to hinder improvement in contrast and cause irregularity of the ambient light absorbing layer. Furthermore, it also has a problem that if the lens sheets are fixed to a television set frame and transported, the sheets collide with each other to make them scratched. For above reasons, the practical use has not been achieved.

### DISCLOSURE OF THE INVENTION

The present invention has been accomplished to solve the above problems and an object of the present invention is thus to provide a lenticular lens sheet, a rear projection screen, and a rear projection apparatus which improve contrast, have low irregularity of an ambient absorbing layer, and prevent scratches due to collision of sheets. Another object is to provide a method of manufacturing a high-performance lenticular lens sheet of the present invention.

To these ends, according to one aspect of the present invention, there is provided a lenticular lens sheet which includes a first lens array formed in an input surface, a second lens array formed closer to a light output side than the first lens array, substantially orthogonal to the first lens array, and constituting an input side and an output side of a lens boundary with light transmitting material having different refractive index from each other, and a self-aligned ambient light absorbing layer placed in a non-passing position of light having passed through the first lens array and the second lens array, wherein a part from the first lens array to the self-aligned ambient light absorbing layer is a solid structure with light transmitting material.

Preferably, a light transmittance front plate is laminated in an output side of the self-aligned ambient light absorbing layer. Further, the second lens array is composed of a plurality of lenses concave toward an input side, and the light transmitting material in the output side of the lens boundary of the second lens array has a lower refractive index than the light transmitting material in the input side. Alternatively, the second lens array is composed of a plurality of lenses convex toward an input side, and the light transmitting material in the output side of the lens boundary of the second lens array has a higher refractive index than the light transmitting material in the input side.

Particularly, a lens pitch of the first lens array is preferably two to ten times a lens pitch of the second lens array. The self-aligned ambient light absorbing layer is lattice-shaped or stripe-shaped.

A rear projection screen is configured by providing a Fresnel lens sheet narrowing down light output from a rear projection projector into a certain angle range, the above lenticular lens sheet, and a front plate placed in an output surface side of the lenticular lens sheet. Further, a rear projection apparatus configured by providing a rear projection projector generating and outputting video light, and a rear projection screen inputting the video light output from the rear projection projector.

A lenticular lens sheet having a different structure according to the present invention includes a first lens layer having a first lens array in an input surface, a second lens layer having a second lens array substantially orthogonal to the first lens array in an output side boundary of the first lens layer and having a different refractive index from the first lens layer; and a self-aligned ambient light absorbing layer placed on an output surface of the second lens layer and in a non-passing position of light having passed through the first lens layer and the second lens layer.

A lenticular lens sheet having a different structure according to the present invention includes a first lens layer having a first lens array, a second lens layer having a second lens array substantially orthogonal to the first lens array, a filled layer filled between the first lens layer and the second lens layer and having a different refractive index from at least the second lens layer; and a self-aligned ambient light absorbing layer placed in a non-passing position of light having passed through the first lens array and the second lens array.

A method of manufacturing a lenticular lens sheet having a first lens layer having a first lens array in an input surface, a second lens layer having a second lens array substantially orthogonal to the first lens array in an output side boundary of the first lens layer and having a different refractive index from the first lens layer, and a self-aligned ambient light absorbing layer on an output surface of the second lens layer and in a non-passing position of light having passed through the first lens layer and the second lens layer, according to the present invention, includes a step of forming the second lens layer, and a step of forming the first lens layer on the second lens layer after forming the second lens layer.

It is preferred to further include a step of forming the self-aligned ambient light absorbing layer, and the step of forming the self-aligned ambient light absorbing layer includes a step of forming a photosensitive material layer in a light output surface side of the lenticular lens sheet; and a step of applying light from an input surface side of the lenticular lens sheet and forming a photosensitive part and a non-photosensitive part corresponding to a lens pattern on the photosensitive material layer, and a light-shielding pattern corresponding to the non-photosensitive part serves as the self-aligned ambient light absorbing layer. The photosensitive part is a relatively high-density photosensitive part, and the non-photosensitive part is a relatively low-density photosensitive part. Thus, the non-photosensitive part is not limited to a part which is not photosensitive at all. A photosensitive material layer in a preferred embodiment is a photosensitive adhesive layer.

Further, it is preferred that the photosensitive material layer is a photocurable composition layer composed of a first composition and a second composition having a lower surface free energy than the first composition, and the method includes a step of applying light to the photocurable composition layer from an input surface side of the lenticular lens sheet in a state where the photocurable composition layer is in contact with a medium with a lower surface free energy than the second composition to cure the photocurable composition layer located in a focus part of the lenticular lens pattern, a step of applying light to the photocurable composition layer from a side of the photocurable composition layer in a state where the photocurable composition layer is in contact with a medium with a higher surface free energy than the first composition to cure the photocurable composition layer located in a non-focus part different from the focus-part, and a step of placing coloring material on the photocurable composition layer and forming a light-shielding pattern corresponding to the non-focus part.

Another method of manufacturing a lenticular lens sheet having a first lens layer having a first lens array in an input surface, a second lens layer having a second lens array substantially orthogonal to the first lens array in an output side boundary of the first lens layer and having a different refractive index from the first lens layer, and a self-aligned ambient light absorbing layer on an output surface of the second lens layer and in a non-passing position of light having passed through the first lens layer and the second lens layer, according to the present invention, includes a step of forming shapes corresponding to the first lens array and the second lens array on the first lens layer, and a step of forming the second lens layer on the first lens layer.

The step of forming shapes corresponding to the first lens array and the second lens array on the first lens layer may include a step of forming the first lens array in the first lens layer, and a step of forming the second lens array in the first lens layer.

Another method of manufacturing a lenticular lens sheet includes a step of forming a first lens layer having a first lens array, a step of forming a second lens layer having a second lens array substantially orthogonal to the first lens array, a step of forming a filled layer having a different refractive index from the first lens layer between the first lens layer and the second lens layer, and a step of forming a self-aligned ambient light absorbing layer in a non-passing position of light having passed through the first lens layer and the second lens layer.

### BRIEF DESCRIPTION OF THE DRAWINGS

FIG. 1 is a perspective view showing a part of the structure of a rear projection screen according to a first embodiment of the invention.

FIG. 2 shows a long section and a cross section of the rear projection screen according to the first embodiment of the invention.

FIG. 3 is a perspective view showing a part of the structure of a rear projection screen according to a second embodiment of the invention and a partly-enlarged view showing the shape of a self-aligned ambient light absorbing layer.

FIG. 4 shows a long section and a cross section of the rear projection screen according to the second embodiment of the invention.

FIG. 5 is a perspective view showing a part of the structure of a rear projection screen according to a third embodiment of the invention.

FIG. 6 shows a long section and a cross section of the rear projection screen according to the third embodiment of the invention.

FIG. 7 is a perspective view showing a part of the structure of a rear projection screen according to a fourth embodiment of the invention.

FIG. 8 is a perspective view showing a part of the structure of a rear projection screen according to a fifth embodiment of the invention.

FIG. 9 shows a long section and a cross section of the rear projection screen according to the fifth embodiment of the invention.

FIG. 10 is a perspective view showing a part of the structure of a rear projection screen according to a sixth embodiment of the invention.

FIG. 11 is a perspective view showing a part of the structure of a rear projection screen according to a seventh embodiment of the invention.

FIG. 12 is a perspective view showing a part of the structure of a rear projection screen according to an eighth embodiment of the invention.

FIG. 13 is a perspective view showing a part of the structure of a rear projection screen according to a ninth embodiment of the invention.

FIG. 14 is a perspective view showing a part of the structure of a rear projection screen according to a tenth embodiment of the invention.

FIG. 15 is a perspective view showing a part of the structure of a rear projection screen according to another embodiment.

FIG. 16 is a cross-sectional view showing the structure of a conventional rear projection screen.

FIG. 17 is a view showing the structure of a rear projection apparatus.

FIG. 18 shows a long section and a cross section of a lens unit element of the embodiment.

FIGS. 19 and 20 are tables showing a combination of specific combination of refractive indexes of a lens unit element and the size measurement of a lens shape regarding embodiments.

### BEST MODES FOR CARRYING OUT THE INVENTION

Embodiments of the present invention are described hereinafter with reference to the drawings.

### EMBODIMENT 1

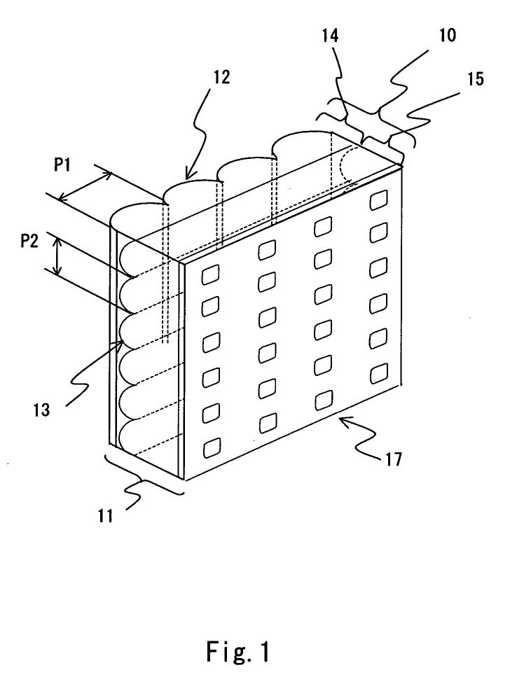

FIG. 1 is a perspective view showing the structure of a principal part of a lenticular lens sheet according to a first embodiment of the invention. Regarding the lenticular lens sheet, the structure which does not include a self-aligned ambient light absorbing layer 17 is referred to as a lenticular lens sheet A (reference number 10), and a sheet where the self-aligned ambient light absorbing layer 17 is provided for the lenticular lens sheet A is referred to as a lenticular lens sheet B (reference number 11) in the following description.

The lenticular lens sheet A is a lenticular lens sheet in which a first lens layer 14 and a second lens layer 15 having different refractive index from each other are integrated together with a second lens array 13 as a boundary surface. In the first embodiment of the invention, the refractive index of the first lens layer 14 is lower than the refractive index of the second lens layer 15.

A first lens array 12 is formed on a light input surface of the lenticular lens sheet A, which is a light input surface of the first lens layer 14, and the second lens array 13 is arranged substantially orthogonal thereto on the boundary between the first lens layer 14 and the second lens layer 15.

The first lens array 12 is composed of a plurality of lens rows consisting of the lenses which are convex toward the near side (input side) when viewed from the light input surface side and act to focus input projection light within a lens medium. Each of the lenses is a cylindrical lens whose longitudinal direction is a vertical direction and they are arranged parallel to each other. Thus, the first lens array 12 can diffuse the light in the horizontal direction on the output surface after focusing the input light within a lens medium. Just like the first lens array 12, the second lens array 13 is composed of lens rows consisting of the lenses which are convex toward the near side (input side) when viewed from the light input surface side. Each of the lenses of the second lens array 13 is a cylindrical lens whose longitudinal direction is a horizontal direction and they are arranged parallel to each other. Thus, the second lens array 13 is formed substantially orthogonal to the first lens array 12. Therefore, by the relationship of refractive index of each lens layer and a lens shape, the second lens array 13 can diffuse the light in the vertical direction on the output surface after focusing the input light within a lens medium.

The lens pitch P1 of the first lens array 12 is two to ten times the lens pitch P2 of the second lens array 13, and preferably it is three to five times. This allows the focus positions of both lenses to be located in the vicinity of each other while avoiding that the valley part of the first lens array 12 and the vertex of the second lens array 13 are connected or adjacent to each other. Further, since the structure of this example places the self-aligned ambient light absorbing layer 17 in the vicinity of the focus positions of both lenses, the area of the self-aligned ambient light absorbing layer 17 can be large, thereby improving contrast.

In the case of a very fine lenticular lens sheet with 0.02 mm or smaller lens pitch P2 of the second lens array, the aperture portion to let projection light to pass through is too fine in the formation of the self-aligned ambient light absorbing layer 17. This makes dots defects likely to occur and mold manufacture difficult. It is therefore preferred that the upper limit of the enlargement ratio of P1 with respect to P2 is about 10 times.

The second lens layer 15 is made of acrylic resin, polycarbonate resin, MS resin (methyl methacrylate-styrene copolymer), polystyrene, PET (polyethylene terephthalate) and so on, for example.

The first lens array 12 which is formed by filling radiation curable resin, for example, is provided on the input surface of the first lens layer 14. The first lens layer 14 is placed to cover the second lens layer 15 with the second lens array 13 as a boundary surface. The output surface of the second lens layer 15 is flat and substantially parallel to the principal plane of the first lens array 12. The principal plane of the first lens array 12 is a plane obtained by connecting the positions of the first lens array 12 which are most convex toward the input side. Stated another way, the second lens array 13 which serves as a boundary between first lens layer 14 and the second lens layer 15 is formed in the first lens layer 14. If the second lens array 13 is expressed as the lenses formed in the first lens layer 14, the lenticular lens is concave-shaped when viewed from the light output side.

The first lens layer 14 is formed of radiation curable resin, for example. The radiation curable resin is selected from acrylic UV curable resin, silicon UV curable resin, fluorine UV curable resin and so on, for example. The first lens layer 14 needs to have a lower refractive index than the second lens layer 15. For example, the first embodiment uses acrylic UV curable resin with a refractive index of 1.49 for the first lens layer and MS resin with a refractive index of 1.58 for the second lens layer. A difference in refractive index between the first lens layer 14 and the second lens layer 15 is preferably 0.05 or above and more preferably 0.1 or above.

The self-aligned ambient light absorbing layer 17 is formed on the output surface of the second lens layer 15. The self-aligned ambient light absorbing layer 17 is placed in non-focus positions of the first lens array 12 and the second lens array 13 where no light passes through. In this example, the self-aligned ambient light absorbing layer 17 is lattice-shaped. The self-aligned ambient light absorbing layer 17 is formed by light shielding photocurable resin, for example.

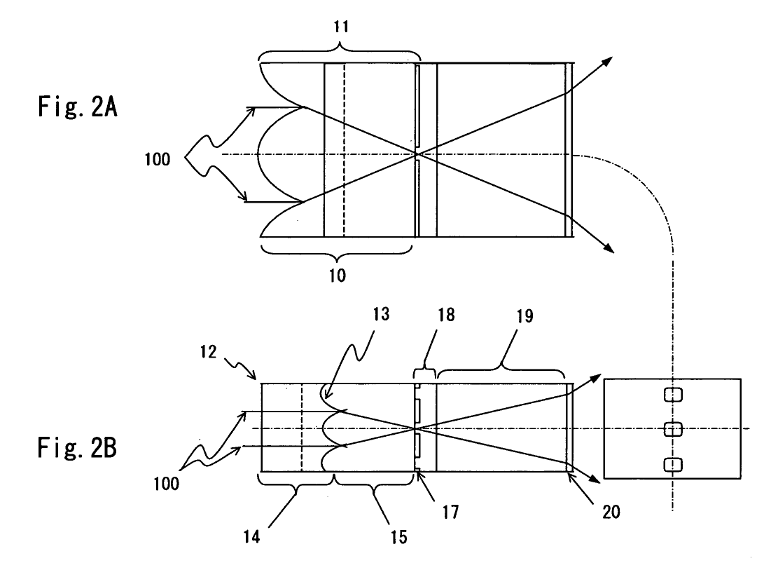

FIG. 2 shows a long section (FIG. 2A) and a cross section (FIG. 2B) of a lenticular lens sheet constituting the rear projection screen according to the first embodiment of the invention, which includes a lamination layer with a front plate 19. The front plate 19 is a light transmission layer which serves also as a base of the lenticular lens sheet B. It may include a diffusion layer or has various functional films such as HC (hardcoat), AG (antiglare), AR (antireflection), AS (antistatic) on the outer most output surface. FIG. 2 also shows a path of light 100 input to the rear projection screen. As shown in FIG. 2, the entire structure of the rear projection screen has the front plate 19 and the functional film 20 in addition to the lenticular lens sheet B. The front plate 19 is adhered to the top surface of the self-aligned ambient light absorbing layer 17 to form a screen unit. The front plate 19, however, may not be adhered to the lenticular lens sheet B but be separated. The front plate 19 is made of acrylic resin, polycarbonate resin, MS resin (methyl methacrylate-styrene copolymer), polystyrene, or the like, for example. The front plate 19 may be a single layer diffusion plate or a multilayer structure having a diffusion layer. The functional film 20 may be formed by directly coating it on the front plate 19 or by laminating a film coated with the functional film 20. The functional film 20 includes HC (hardcoat), AG (antiglare), AR (antireflection), AS (antistatic), and so on.

As shown in the long sectional view of FIG. 2A, the light 100 incident on the input surface of the lenticular lens sheet A is refracted by the first lens array 12 so as to focus in the horizontal direction, passes through the first lens layer 14, focus in each lens medium of the second lens layer 15, and is then output. As shown in the cross sectional view of FIG. 2B, the light 100 is refracted by the second lens array 13 in the vertical direction and focuses in the second lens layer 14 and is then output. Thus, the self-aligned ambient light absorbing layer 17 is located in the vicinity of the focus points of both the first lens array 12 and the second lens array 13. Placing the self-aligned ambient light absorbing layer 17 in the vicinity of the focus points of both lenses allows contrast to further increase. Besides, it is possible to make the focus positions of the first lens array and the second lens array differ and form the self-aligned ambient light absorbing layer 17 in stripe pattern.

As described in the foregoing, the rear projection screen according to the first embodiment of the invention has the self-aligned ambient light absorbing layer 17 on the output surface of the lenticular lens sheet A composed of the first lens array 12 and the second lens array 13 orthogonal to each other, and forms a solid structure from the first lens array 12 to the self-aligned ambient light absorbing layer 17 with light transmitting material, so that the self-aligned ambient light absorbing layer 17 can be formed accurately. Particularly, since this embodiment allows the self-aligned ambient light absorbing layer 17 to be formed accurately in such a way that the focus positions of the first lens array 12 and the second lens array 13 are located in the vicinity of the position of the self-aligned ambient light absorbing layer 17, the contrast performance can be improved.

Further, since the rear projection screen of this embodiment can reduce diffusion material, it is possible to avoid images out of focus and increase resolution.

A method of manufacturing the rear projection screen according to the first embodiment of the invention is described below.

First, the second lens layer 15 having the second lens array 13 in the lenticular lens sheet A is produced. For example, a base resin of the second lens layer 15 is melt extruded with a T-die and a cylindrical lens is molded in one side with a shaping roller. In this case, the maximum thickness of the second lens layer is made so as to be substantially uniform overall.

The shape transfer direction of the cylindrical lens against the shaping roller may be transverse so that a concave groove line is parallel to the rotation center axis of the shaping roller or vertical so that the concave groove line is perpendicular to the rotation center axis. Alternatively, instead of the melt extrusion molding, base resin may be press-molded with a single side concave groove mold or it may be injection-molded in one side.

After that, the first lens layer 14 having the first lens array 12 is molded on the second lens array 13 with light transmitting material having a lower refractive index than the second lens layer 15. In this case also, the principal plane of the first lens array 12 needs to be substantially parallel to the output surface of the second lens layer 15 on which the self-aligned ambient light absorbing layer 17 is formed. This is easily achievable by adjusting the tension of the second lens layer 15 and the viscosity of transparent radiation curable resin. The first lens layer 14 may be molded by pressing against a flat plate mold with a hollow cylindrical transparent glass tube to which an UV irradiation lamp is inserted inside. The above molding process preferably involves a process to increase adhesion such as plasma processing on the surface of the second lens array 13, for example.

Further, a film coated with light-shielding photocurable resin is adhered to the light output surface of the second lens layer 15 of the lenticular lens sheet A integrated in the above process. Then, UV ray is applied from the input side of the lenticular lens sheet. The light-shielding photocurable resin in the UV irradiated part is thereby cured. The film is stripped off after that. The light-shielding photocurable resin in the UV non-irradiated part is left uncured in a lattice pattern on the output surface of the second lens layer 15. The light-shielding photocurable resin in the UV irradiated part is stripped off by being attached to the film.

Then, the un-cured light-shielding photocurable resin in the non-irradiated part, which is left in lattice pattern, is cured by nuclear radiation from the output side of the lenticular lens sheet. The self-aligned ambient light absorbing layer 17 is thereby formed. The formation of the self-aligned ambient light absorbing layer 17 is not limited to the above method. For example, it is possible to use a method that forms a photosensitive adhesive layer on the light output surface of the second lens layer 15 and applies an exposure light beam from the input surface side so as to form an exposure part and a non-exposure part corresponding to the shape and pitch of the lenses, and then forms a black color layer on the surface of the photosensitive adhesive layer and transfers the black color layer only into the non-exposure part of the photosensitive adhesive layer by lamination means. The exposure part is a relatively high-density exposure part and the non-exposure part is a relatively low density exposure part. Thus, the non-exposure part is not restricted to a part which is not exposed at all.

The self-aligned ambient light absorbing layer 17 may be formed by using a difference in surface free energy between the exposure and non-exposure parts. For example, a layer of composition made up of 100 mass % light curable resin composition (a) with surface free energy of 30 mN/m or above and 0.01 to 10 mass % compound (b) with surface free energy of 25 mN/m or below is formed on the light output surface of the second lens layer 15. Then, an exposure beam is applied from the lens side in the state in contact with medium (for example, atmospheric air) with lower surface free energy than the compound (b). The applied light is focused by the lens and the light curable composition (A) in the focus part only is selectively cured. It is thereby possible to obtain a lens sheet whose surface energy in the focus part is 25 mN/m or below. Then, an exposure beam is applied from the lens sheet output surface side in the state where the obtained lens sheet is in contact with medium (for example, water) with higher surface free energy than the light curable resin composition (a), so that the un-cured light curable composition (A) only is cured. On the surface with different surface free energy, wettability of each kind of liquid also differs. In the case of solvent and coating material generally used, liquid is more wettable to the surface with higher surface free energy than the surface with lower surface free energy. Therefore, the surface-modified lens sheet is more wettable by various liquid in the non-focus part than in the focus part. Using this property, if pigmented coating is applied onto the surface-modified lens sheet, it is possible to form a light-shielding pattern where the pigmented coating is attached only to the non-focus part.

After that, the front plate 19 is laminated on the self-aligned ambient light absorbing layer 17. The lamination is made by adhesion with radiation curable resin or adhesive material.

Further, the functional film 20 may be laminated on the surface of the front plate 19. Specifically, the functional film 20 is directly coated on the front plate 19 or a film coated with the functional film 20 is laminated.

This manufacturing method can produce a rear projection screen having the structure shown in FIGS. 1 and 2.

### EMBODIMENT 2

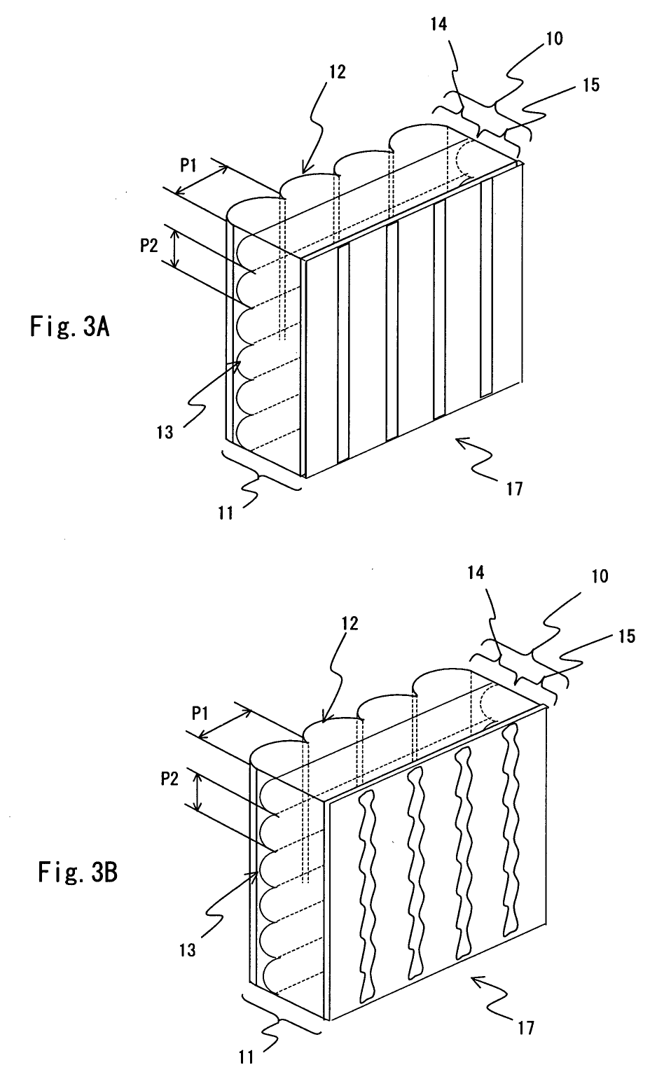

FIG. 3A is a perspective view showing the structure of a principal part of a rear projection screen according to the second embodiment of the invention. The rear projection screen of the second embodiment is different from that of the first embodiment in the relationship between the refractive indexes of the first lens layer 14 and the second lens layer 15. It has an opposite structure that the refractive index of the first lens layer 14 is higher than that of the second lens layer 15. Thus, the output light having passed through the second lens array 13 does not focus in the vertical direction within the lens medium, and the self-aligned ambient light absorbing layer 17 is stripe-shaped. In the example shown in FIG. 3A, the self-aligned ambient light absorbing layer 17 has a uniform line width and a linear boundary between an ambient light absorbing layer and a light transmission part. However, depending on optical design such as a lens shape, the line width can change periodically and the boundary between the ambient light absorbing layer and the light transmission part can be wavy in some cases as shown in FIG. 3B. This specification refers to both the shapes shown in FIGS. 3A and 3B of the self-aligned ambient light absorbing layer 17 as stripe-shape.

Since principal diffusion in the vertical direction is obtained by the refraction of the lens unlike the conventional technique (FIG. 16), it is possible to significantly reduce the adding amount of light diffusion material to the front plate 19. Therefore, though the area of the self-aligned ambient light absorbing layer 17 is the same as in the lenticular lens sheet of the conventional technique (FIG. 16), the contrast performance is improved. Further, an advantage of the second embodiment is that the viewing angle in the vertical direction is flexibly variable without substantially changing the viewing angle characteristics in the horizontal direction by changing the curvature of the second lens array 13, the lens pitch P2 with respect to the lens pitch P1 of the first lens array 12 and so on. The other structure is the same as in the first embodiment and the description is omitted.

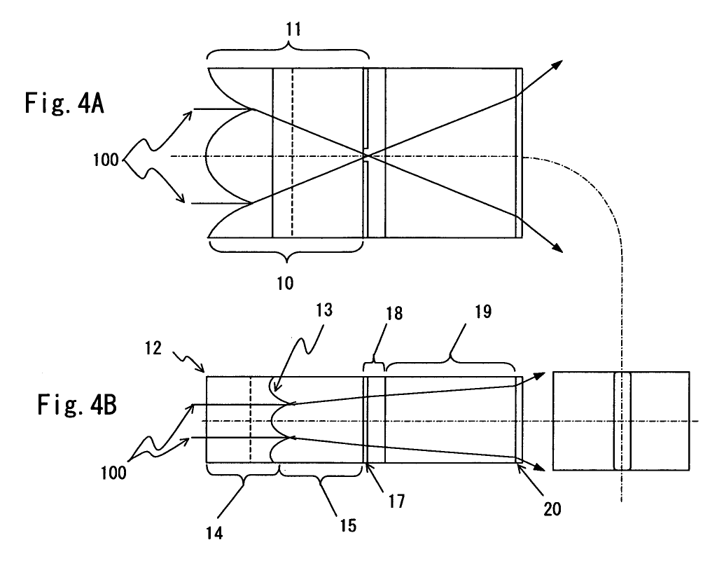

FIG. 4 shows a long section (FIG. 4A) and a cross section (FIG. 4B) of the rear projection screen according to the second embodiment of the invention. FIG. 4 also shows the path of the light 100 input to the rear projection screen.

As shown in FIG. 4, the rear projection screen has the front plate 19 and the functional layer 20 in addition to the lenticular lens sheet B. As shown in the long sectional view of FIG. 4A, the light 100 incident on the input surface of the lenticular lens sheet A is refracted by the first lens array 12, focuses within each of the first and second lens layers, and is then output. As shown in the cross sectional view of FIG. 4B, the input light is refracted in the vertical direction by the second lens array 13, passes through the front plate 19, and is then output. In FIG. 4 also, the self-aligned ambient light absorbing layer 17 is placed in the position which does not shield the light output through each lens layer, which is the non-focus position. The self-aligned ambient light absorbing layer 17 is thus placed in the vicinity of the focus point of the first lens array 12, and since the vertical direction is spread upward and downward by the second lens array 13, the self-aligned ambient light absorbing layer 17 is stripe-shaped.

As described in the foregoing, the rear projection screen of the second embodiment of the invention can form the stripe-shaped self-aligned ambient light absorbing layer 17 accurately on the output surface side of the lenticular lens sheet A having the first lens array 12 and the second lens array 13. Further, according to the rear projection screen of the second embodiment, though the area of the self-aligned ambient light absorbing layer 17 is not different from the screen of the conventional technique, diffusion material applied to the front plate 19 can be reduced; therefore, it is possible to avoid images out of focus and increase resolution. Furthermore, it has a great advantage that the viewing angle characteristics in the vertical direction is flexibly adjustable by changing the curvature of the second lens array 13, the lens pitch P2 with respect to the first lens array 12, and so on.

A method of manufacturing the rear projection screen according to the second embodiment of the invention is different from that of the first embodiment only in that the relationship of the refractive indexes of the first lens layer 14 and the second lens layer 15 constituting the lenticular lens sheet A is opposite, and thus the description is omitted.

### EMBODIMENT 3

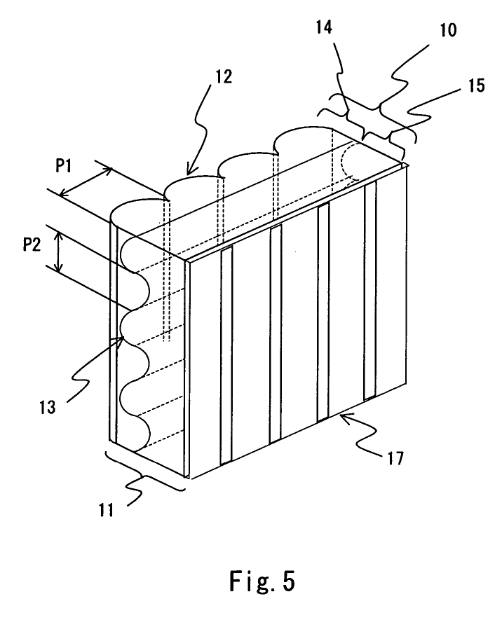

FIG. 5 is a perspective view showing the structure of a principal part of a rear projection screen according to a third embodiment of the present invention. The rear projection screen of the third embodiment is different from that of the first embodiment in the shape of the second lens array 13 of the lenticular lens sheet A. Specifically, in the third embodiment, the second lens array 13 is formed in such a way that the cross section has a sine waveform. Further, in the rear projection screen of the third embodiment, the shape of the self-aligned ambient light absorbing layer 17 is stripe-shaped just like in the second embodiment. Also just like in the second embodiment, the lens pitch P2 of the second lens array 13 in the third embodiment may be set arbitrarily with respect to the lens pitch P1 of the first lens array 12. Furthermore, the second lens array 13 may have a prism shape or may be a complex lens array composed of a combination of lenses with different curvatures. The other structure is the same as in the first and second embodiments, and the description is thus omitted.

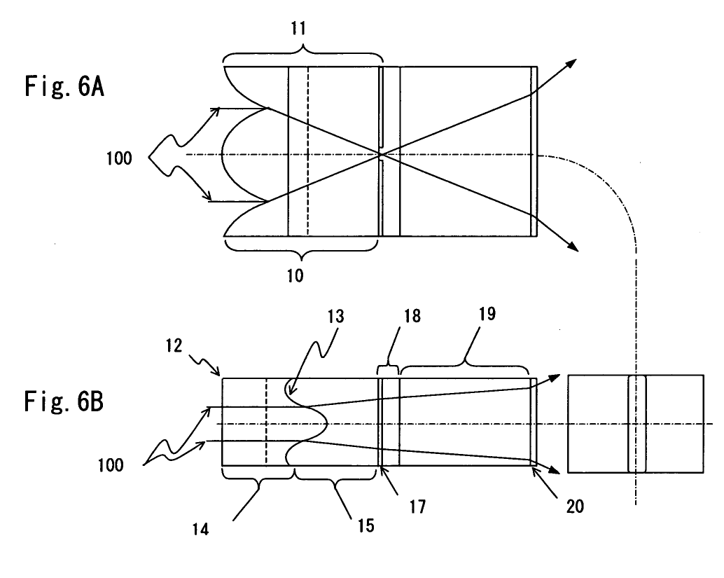

FIG. 6A shows a long sectional view of the rear projection screen of the third embodiment of the invention and FIG. 6B shows a cross-sectional view of the same. FIGS. 6A and 6B also show the path of the light 100 input to the rear projection screen.

As shown in FIGS. 6A and 6B, the rear projection screen has the front plate 19 and the functional layer 20 in addition to the lenticular lens sheet B. As shown in the long sectional view of FIG. 6A, the light 100 incident on the input surface of the lenticular lens sheet A is refracted by the first lens array 12, focuses within each of the first and second lens layers, and is then output. As shown in the cross sectional view of FIG. 6B, the light 100 is refracted in the vertical direction by the second lens array 13 and is then output.

As described in the foregoing, the rear projection screen of the third embodiment of the invention can form the stripe-shaped self-aligned ambient light absorbing layer 17 accurately on the output surface side of the lenticular lens sheet A having the first lens array 12 and the second lens array 13. Further, according to the rear projection screen of the third embodiment, though the area of the self-aligned ambient light absorbing layer 17 is not different from the screen of the conventional technique (FIG. 16), diffusion material applied to the front plate 19 can be reduced and it is thereby possible to avoid images out of focus and increase resolution, just like in the second embodiment. Furthermore, it has a great advantage that the viewing angle characteristics in the vertical direction is flexibly adjustable by changing the curvature of the second lens array 13, the lens pitch with respect to the first lens array 12, and so on.

A method of manufacturing the rear projection screen according to the third embodiment of the invention is different from that of the first embodiment only in the shape of the second lens array 13 serving as a boundary between the first lens layer 14 and the second lens layer 15 constituting the lenticular lens sheet A, and thus the description is omitted.

### EMBODIMENT 4

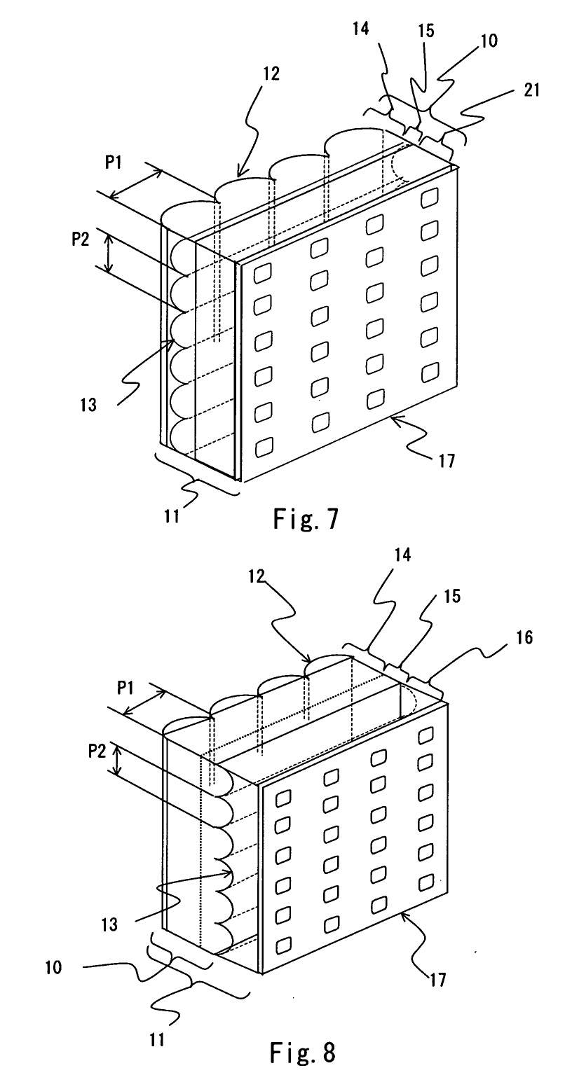

FIG. 7 is a perspective view showing the structure of a principal part of the lenticular lens sheet according to a fourth embodiment of the invention.

The lenticular lens sheet A is different from that in the first embodiment in that a transparent base 21 is provided on the output side of the second lens layer 15 and the self-aligned ambient light absorbing layer 17 is placed on the output side surface of the transparent base 21. The other structure is the same as that of the first embodiment and thus the description is omitted.

For the transparent base 21, an acrylic resin film, MS resin film, PET film, or the like is used.

The rear projection screen of the fourth embodiment can accurately form the self-aligned ambient light absorbing layer 17 because the self-aligned ambient light absorbing layer 17 is placed on the output surface of the transparent base 21 having the first lens array 12 and the second lens array 13 orthogonal to each other. Particularly, since this embodiment allows accurate formation of the self-aligned ambient light absorbing layer 17 so that the focus positions of the first lens array 12 and the second lens array 13 are in the vicinity of the position where the self-aligned ambient light absorbing layer 17 is placed, the contrast performance can be further improved.

Further, the rear projection screen of this embodiment allows reduction of diffusion material, and thereby it can avoid images out of focus and improve resolution.

A method of manufacturing the rear projection screen according to the fourth embodiment of the invention is described below.

First, the second lens layer 15 having the second lens array 13 is molded on the light input side surface of the transparent base 21. For example, transparent radiation curable resin is directly coated on the surface of the transparent base 21, coated on a shaping roller or coated on the both surfaces and then radiation ray is applied to cure the resin and then taken out.

The shape transfer direction of the cylindrical lens in the shaping roller may be transverse in which a concave groove line is parallel to the rotation center axis of the shaping roller or vertical in which the concave groove line is perpendicular to the rotation center axis.

Instead of the shaping roller, a flat plate mold with one-side concave grooves may be used.

Then, the first lens layer 14 is molded on the second lens array 13 which serves as the light input surface of the second lens layer 15 integrated with the transparent base 21 obtained by the above process with transparent radiation curable resin having a lower refractive index than the second lens layer 15. In this case, the first lens layer 14 is molded so that the first lens array 12 is substantially orthogonal to the second lens array 13. The principal plane of the first lens array 12 needs to be substantially parallel to the principal plane of the second lens array 13, and it is possible to form it accurately and uniformly by adjusting the tension to the transparent base 21 integrated with the second lens layer 15 and the viscosity of the transparent radiation curable resin for the first lens layer. Alternatively, the first lens layer 14 may be molded by pressing it against a flat plate mold with a hollow cylindrical transparent glass tube to which an UV irradiation lamp is inserted inside. Further, the above molding process preferably involves a process to increase adhesion such as plasma processing on the surface of the second lens array 13, for example.

Further, a film coated with light-shielding photocurable resin is adhered onto the surface of the transparent base 21 which is the output surface of the lenticular lens sheet A integrated in the above process, and the self-aligned ambient light absorbing layer 17 is formed by the process described in the first embodiment.

The above manufacturing method produces a rear projection screen having the structure shown in FIG. 7.

In the lenticular lens sheet A having the structure shown in FIG. 7, the refractive index of the first lens layer 14 may be higher than that of the second lens layer 15. In this case, the output light having passed through the second lens array 13 does not focus in the vertical direction within the lens medium, and the self-aligned ambient light absorbing layer 17 is stripe-shaped.

Further, in the lenticular lens sheet A having the structure shown in FIG. 7, the second lens array 13 may be formed in such a way that its cross section has a sine waveform. In this case, the self-aligned ambient light absorbing layer 17 is stripe-shaped just like in the third embodiment.

### EMBODIMENT 5

FIG. 8 is a perspective view showing the structure of a principal part of the lenticular lens sheet according to a fifth embodiment of the invention. In this example, the lenticular lens sheet part composed of the first lens layer 14 and the second lens layer 15 is referred to as a lenticular lens sheet A (reference number 10), and the lenticular lens sheet further including a filled layer 16 and the self-aligned ambient light absorbing layer 17 is referred to as a lenticular lens sheet B (reference number 11). The lenticular lens sheet A has the first lens array 12 on the input surface and the second lens array 13 substantially orthogonal to the first lens array 12 on the output surface. In addition, in the fifth embodiment of the invention, a combination of the refractive indexes of the lens layers constituting the lenticular lens A is higher than the refractive index of the filled layer 16.

The first lens array 12 is the same as in the first embodiment and the description is thus omitted.

The second lens array 13 is composed of a plurality of lenses which are convex toward the near side (output side) when viewed from the light output surface side. Each of the lenses is a cylindrical lens whose longitudinal direction is a horizontal direction and they are arranged parallel to each other. Thus, the second lens array 13 is formed substantially orthogonal to the first lens array 12. Therefore, by the relationship of refractive index and a lens shape, the second lens array 13 can diffuse the light in the vertical direction on the output surface after focusing the input light within a lens medium.

The lens pitch P1 of the first lens array 12 is two to ten times the lens pitch P2 of the second lens array 13, and preferably it is three to five times.

On the output surface side of the lenticular lens sheet A, the filled layer 16 formed by filling resin is placed. The filled layer 16 is placed to contact the lens boundary of the second lens array 13 and cover it. The other surface of the filled layer 16 from the surface in contact with the second lens array 13 is flat and parallel to the principal plane of the lenticular lens sheet A.

Since the second lens array 13 serving as the output surface of the lenticular lens sheet A is formed in the boundary with the filled layer 16, this lens array is formed in the filled layer 16, stated another way. If it the second lens array 13 is expressed as the lens formed in the filled layer 16, the lenticular lens is concave-shaped when viewed from the light input side.

The filled layer 16 needs to have a different refractive index from the second lens layer, and radiation curable resin is used for example. As shown in FIG. 8, in the case of the fifth embodiment of the invention, in order that the second lens array 13 formed in the output surface of the lenticular lens sheet A functions as a convex lens to focus light, it is necessary to set the refractive index of the filled layer 16 to be lower than the refractive index of the lenticular lens sheet A. For example, acrylic UV curable resin with the refractive index of 1.49 is used for the filled layer 16, MS resin with the refractive index of 1.58 is used for the first lens layer 14 of the lenticular lens sheet A, and MS UV curable resin with substantially the same refractive index is used for the second lens layer 15.

On the flat output surface of the filled layer 16 is the self-aligned ambient light absorbing layer 17. The self-aligned ambient light absorbing layer 17 is formed in the non-focus parts or light non-passing parts of the first lens array 12 and the second lens array 13. In this example, the self-aligned ambient light absorbing layer 17 is formed in a lattice shape. The self-aligned ambient light absorbing layer 17 is formed by light-shielding photocurable resin, for example.

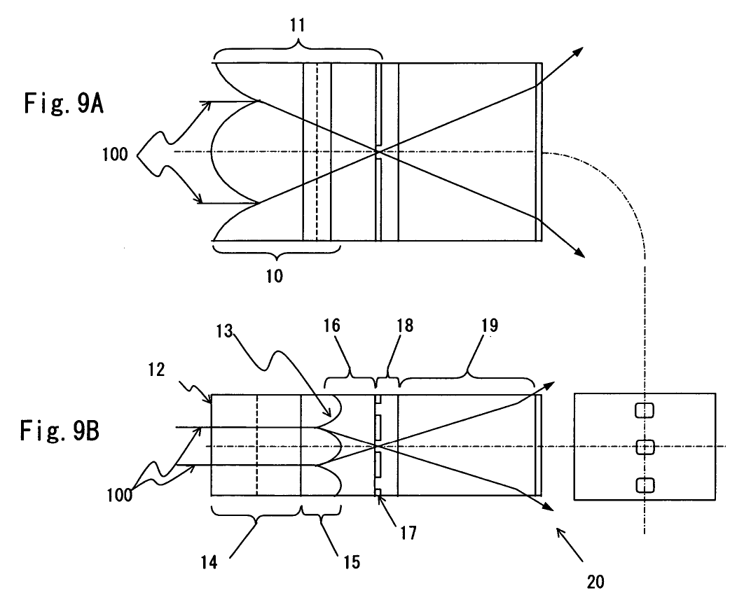

FIGS. 9A and 9B show a long sectional view and a cross sectional view, respectively, of the rear projection screen including a lamination layer having the front plate 19 according to the fifth embodiment of the invention. FIG. 9 also shows the pass of the light 100 input to the rear projection screen.

As shown in the long sectional view of FIG. 9A, the light 100 incident on the input surface of the lenticular lens sheet A is refracted by the second lens array 13, focuses in each lens medium of the lenticular lens sheet A and the filled layer 16, and is then output. As shown in the cross sectional view of FIG. 9B, the input light is refracted in the vertical direction by the second lens array 13, focuses within the filled layer 16, and is then output. Thus, the self-aligned ambient light absorbing layer 17 is placed in the vicinity of the focus points of both the first lens array 12 and the second lens array 13. Placing the self-aligned ambient light absorbing layer 17 in the vicinity of the focus points of both the lenses improves contrast.

As described in the foregoing, the rear projection screen of the fifth embodiment of the invention has the filled layer 16 on the output surface of the lenticular lens sheet A composed of the lens arrays 12 and 13 orthogonal to each other and the self-aligned ambient light absorbing layer 17 on top of the filled layer 16, and forms a solid structure from the first lens array 12 to the self-aligned ambient light absorbing layer 17 with light transmitting material. Therefore, the self-aligned ambient light absorbing layer 17 can be formed accurately in the positional relationship with the lens arrays 12 and 13 and the filled layer 16. Particularly, since this embodiment allows the self-aligned ambient light absorbing layer 17 to be formed accurately in such a way that the focus positions of both the first lens array 12 and the second lens array 13 are located in the vicinity of the position of the self-aligned ambient light absorbing layer 17, the contrast performance can be improved. Further, since the rear projection screen of this embodiment can reduce diffusion material, it is possible to avoid images out of focus and increase resolution.

A method of manufacturing the rear projection screen according to the fifth embodiment of the invention is described below.

First, the first lens layer 14 having the first lens array 12 in the lenticular lens sheet A is produced. For example, a base resin of the first lens layer 14 is melt extruded with a T-die and one side of a cylindrical lens is molded with a shaping roller. In this case, the shape transfer direction of the cylindrical lens against the shaping roller may be transverse so that a concave groove line is parallel to the rotation center axis of the shaping roller or vertical so that the concave groove line is perpendicular to the rotation center axis.

Instead of the melt extrusion molding, base resin may be press-molded with a single-side concave groove mold or it may be injection-molded in one side.

Then, the second lens layer 15 having the second lens array 13 is molded on the light output surface side of the first lens layer 14 obtained by the above process with transparent radiation curable resin having substantially the same refractive index as the base resin of the first lens layer 14. In this case, the second lens layer 15 is molded so that the second lens array 13 is substantially orthogonal to the first lens array 12. The second lens layer 15 needs to be substantially parallel to the principal plane of the first lens layer 14, and it is possible to form the interval between the lenses of each lens array accurately and uniformly by adjusting the tension to an original layer of the first lens layer 14 and the viscosity of the transparent radiation curable resin for the second lens layer 15.

Alternatively, the second lens array 13 may be molded with transparent radiation curable resin by wrapping an original layer of the first lens layer 14 molded by extrusion shaping around a mold shaping roller and applying radiation to cure it, or by pressing it against a flat plate mold with a hollow cylindrical transparent glass tube to which an UV irradiation lamp is inserted inside. Further, the above molding process preferably involves a process to increase adhesion such as plasma processing on the surface of the second lens array 13, for example.

After that, on the second lens array 13, the filled layer 16 having a lower refractive index than the second lens layer 15 is molded with transparent radiation curable resin. In this case also, the principal plane of the filled layer 16 which forms the self-aligned ambient light absorbing layer 17 needs to be substantially parallel to the principal plane of each of the first and second lens layers, and this is easily achievable by adjusting the tension of the lenticular lens sheet A integrated in the above process and the viscosity of transparent radiation curable resin.

Further, a film coated with light-shielding photocurable resin is adhered onto the top surface of the filled layer 16, and the self-aligned ambient light absorbing layer 17 is formed by the process described in the first embodiment.

The above manufacturing method produces a rear projection screen having the structure shown in FIG. 8.

In the lenticular lens sheet A having the structure shown in FIG. 8, the refractive index of the filled layer 16 may be higher than that of the second lens layer 15. In this case, the output light having passed through the second lens array 13 does not focus in the vertical direction within the lens medium, and the self-aligned ambient light absorbing layer 17 is stripe-shaped.

Further, in the lenticular lens sheet A having the structure shown in FIG. 8, the second lens array 13 may be formed in such a way that its cross section has a sine waveform. In this case, the self-aligned ambient light absorbing layer 17 is stripe-shaped just like in the third embodiment.

### EMBODIMENT 6

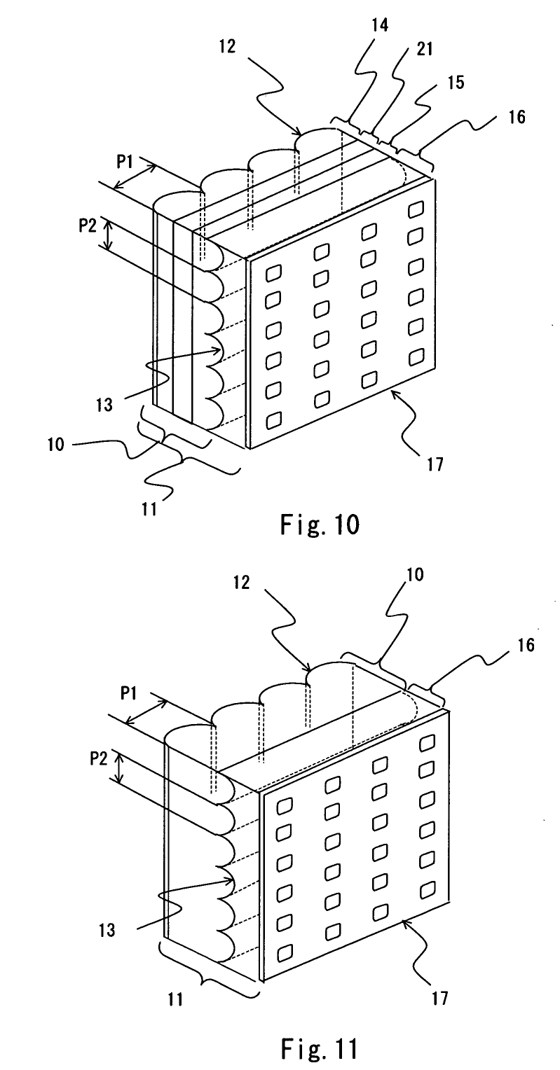

FIG. 10 is a perspective view showing the structure of a principal part of the lenticular lens sheet according to a sixth embodiment of the invention. The sixth embodiment is different from the fifth embodiment in that the first lens layer 14 and the second lens layer 15 are formed on the transparent base 21. The other structure is the same and the description is omitted.

The lenticular lens sheet of the sixth embodiment of the invention has the same effect as the lenticular lens sheet of the fifth embodiment.

A method of manufacturing the rear projection screen according to the sixth embodiment of the invention is described hereinafter.

First, one side of the first lens layer 14 having the first lens array 12 is molded on the surface of the transparent base 21. An exemplary way is to coat transparent radiation curable resin on the surface of the transparent base 21 or the shaping roller and adhere them, or to coat it on the surfaces of the both and adhere them, and then apply a radiation ray from the side of the transparent base 21 to cure them, and finally take it out. In this case, the thickness of the first lens layer 14 can be formed accurately and uniformly by adjusting the tension to an original of the transparent base 21 and using a proper year of the transparent radiation curable resin.

The shape transfer direction of the cylindrical lens in the shaping roller may be transverse in which a concave groove line is parallel to the rotation center axis of the shaping roller or vertical in which the concave groove line is perpendicular to the rotation center axis.

Then, on the opposite surface of the transparent layer 21 integrated with the first lens layer 14, the second lens layer 15 having the second lens array is molded with transparent radiation curable resin. In this case, the second lens layer 15 is formed so that the second lens array 13 is substantially orthogonal to the first lens array 12. The principal plane of the second lens array 13 needs to be substantially parallel to the principal plane of the first lens array 12, and it is possible to form the interval between the lenses of each lens array accurately and uniformly by adjusting the tension to an original of the transparent base 21 integrated with the first lens layer 14 in the above process and the viscosity of the transparent radiation curable resin for the second lens layer 15. Further, the above molding process preferably involves a process to increase adhesion such as plasma processing on the surface of the transparent base 21, for example.

After that, on the second lens array 13, the filled layer 16 having a lower refractive index than the second lens layer 15 is molded with transparent radiation curable resin. In this case also, the tension of the lenticular lens sheet A integrated with the lens layers and the viscosity of the transparent radiation curable resin are adjusted so that the principal plane of the filled layer 16 which forms the self-aligned ambient light absorbing layer 17 is substantially parallel to the principal plane of each of the first and second lens arrays and has a uniform thickness.

A process for molding onto the surface of the transparent base 21 with transparent radiation curable resin is not limited to the above described process. For example, a process may first shape the second lens layer 15 on the transparent base 21 or first shape the second lens layer 15, then shape the filled layer 16 in the next step and finally shape the first lens layer 14.

It is also possible to wrap the transparent base 21 continuously around a shaping roller and applying a radiation ray to cure it, or to press it against a flat plate mold with a hollow cylindrical transparent glass tube to which an UV irradiation lamp is inserted inside. The above molding process preferably involves a process to increase adhesion such as plasma processing on the surface of the second lens array 13, for example.

Further, a film coated with light-shielding photocurable resin is adhered onto the surface of the filled layer 16, and the self-aligned ambient light absorbing layer 17 is formed by the process described in the first embodiment.

In the lenticular lens sheet A having the structure shown in FIG. 10, the refractive index of the filled layer 16 may be higher than that of the second lens layer 15. In this case, the output light having passed through the second lens array 13 does not focus in the vertical direction within the lens medium, and the self-aligned ambient light absorbing layer 17 is stripe-shaped.

Further, in the lenticular lens sheet A having the structure shown in FIG. 10, the second lens array 13 may be formed in such a way that its cross section has a sine waveform. In this case, the self-aligned ambient light absorbing layer 17 is stripe-shaped.

### EMBODIMENT 7

FIG. 11 is a perspective view showing the structure of a principal part of a lenticular lens sheet according to a seventh embodiment of the invention. The lenticular lens sheet of the seventh embodiment has the same structure as but is manufactured differently from the lenticular lens sheet of the fifth embodiment shown in FIG. 9 as described below.

First, the lenticular lens sheet A is produced. For example, a base resin of the lens sheet is melt extruded with a T-die and both sides of cylindrical lens arrays are molded at the same time with a shaping roller. In this case, the shape transfer of the cylindrical lens against the shaping roller is performed at the same time in the combination of a transverse groove roller in which a concave groove line is parallel to the rotation center axis of the shaping roller and a vertical groove roller in which the concave groove line is perpendicular to the rotation center axis.

Instead of the melt extrusion molding, base resin may be press-molded with a two-side mold or both sides of lens arrays may be formed at the same time by injection molding.

After that, the filled layer 16 having a lower refractive index than the lens layer of the lenticular lens sheet A is molded with transparent radiation curable resin. In this case also, the principal plane of the filled layer 16 which forms the self-aligned ambient light absorbing layer 17 needs to be substantially parallel to the principal plane of the two-side cylindrical lens sheet. This is easily achievable by adjusting the tension of the two-side cylindrical lens sheet and the viscosity of transparent radiation curable resin.

The filled layer 16 may be molded with transparent radiation curable resin by wrapping an original of the lenticular lens sheet A molded by extrusion shaping around a mold shaping roller and applying a radiation ray thereto to cure it, or by pressing it against a flat plate mold with a hollow cylindrical transparent glass tube to which an UV irradiation lamp is inserted inside. The above molding process preferably involves a process to increase adhesion such as plasma processing on the surface of the second lens array 13, for example.

Further, a film coated with light-shielding photocurable resin is adhered onto the surface of the filled layer 16, and the self-aligned ambient light absorbing layer 17 is formed by the process described in the first embodiment.

In the lenticular lens sheet A having the structure shown in FIG. 11, the refractive index of the filled layer 16 may be higher than that of the second lens layer 15. In this case, the output light having passed through the second lens array 13 does not focus in the vertical direction within the lens medium, and the self-aligned ambient light absorbing layer 17 is stripe-shaped.

Further, in the lenticular lens sheet A having the structure shown in FIG. 11, the second lens array 13 may be formed in such a way that its cross section has a sine waveform. In this case, the self-aligned ambient light absorbing layer 17 is stripe-shaped.

### EMBODIMENT 8

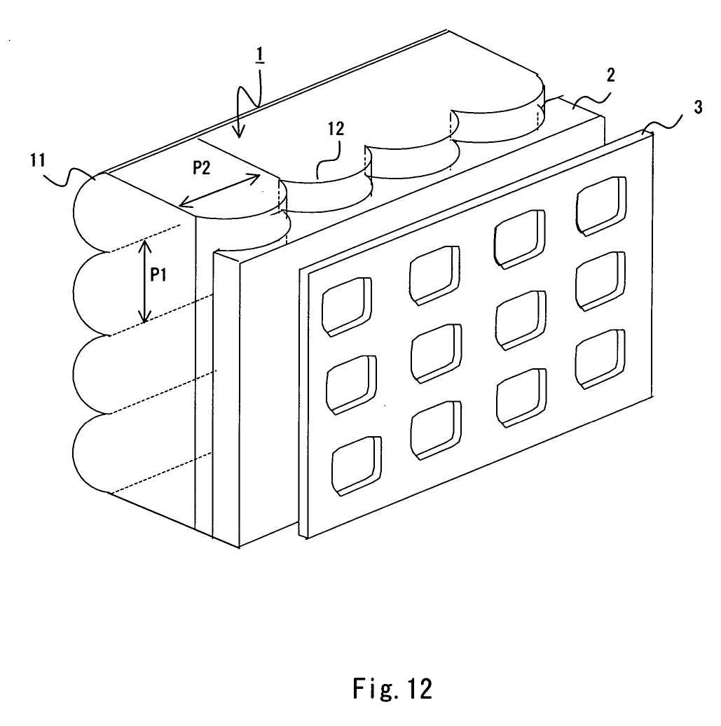

Though the lenticular lens sheet according to the first to seventh embodiments is composed of a combination of the lens shape and refractive index in which the first lens array controls diffusion in the horizontal direction and the second lens array controls diffusion in the vertical direction, an opposite structure may be used. Specifically, it is possible to make a structure that the first lens array is a cylindrical lens array whose longitudinal direction is a horizontal direction, and the second lens array is a cylindrical lens array whose longitudinal direction is a vertical direction as shown in FIG. 12.

### EMBODIMENT 9

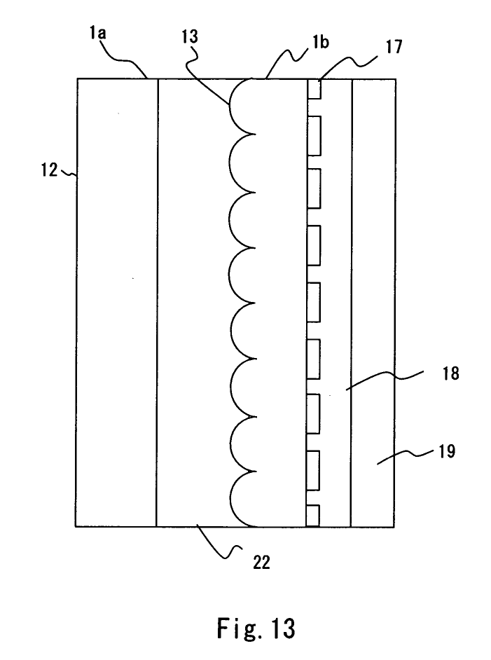

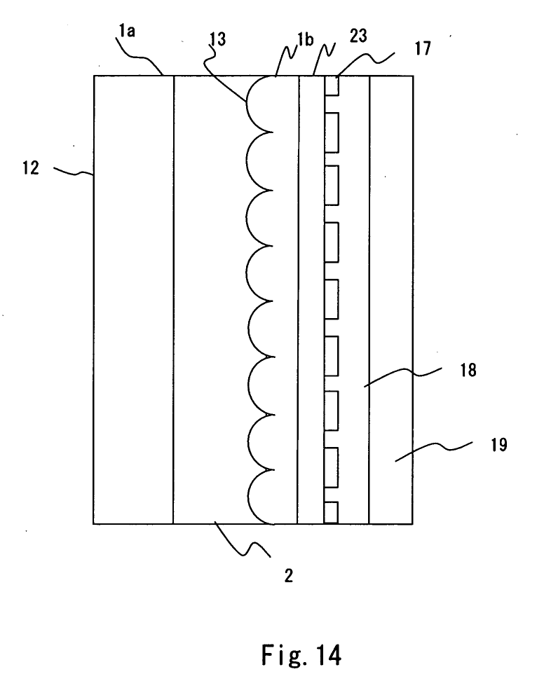

FIG. 13 shows a section of a rear projection screen according to a ninth embodiment of the invention. In the ninth embodiment, a pair of lenticular lens sheets 1a and 1b is provided. The lenticular lens sheet 1a has the first lens array 12 arranged vertically to the input surface. The output surface of the lenticular lens sheet 1a is flat, and a self-aligned ambient light absorbing layer is not placed. The lenticular lens sheet 1b has the second lens array 13 arranged horizontally to the input surface. Thus, the first lens array 12 and the second lens array 13 are substantially orthogonal to each other. The lens pitch P1 of the first lens array 12 is longer than the lens pitch P2 of the second lens array 13, and it is two to ten times, for example, and preferably three to five times. This allows the focus points of the both lens to be located in the vicinity of each other.

On the output surface of the lenticular lens sheet 1b is the self-aligned ambient light absorbing layer 17. The self-aligned ambient light absorbing layer 17 is placed in the non-focus part in the vicinity of the focus points of the first lens array 12 and the second lens array 13. In this example, the self-aligned ambient light absorbing layer 17 is lattice-shaped.

A filled layer 22 is formed between the lenticular lens sheets 1a and 1b. Placing the filled layer 22 allows the lenticular lens sheets 1a and 1b to be located in the accurate positions to each other. Particularly, since the first lens array 12 formed in the lenticular lens sheet 1a needs to be placed so as to have a focus point in the vicinity of the self-aligned ambient light absorbing layer 17 formed on the output surface of the lenticular lens sheets 1b, the effect of accurately positioning the lenticular lens sheets 1a and 1b is high in this point of view as well.

The filled layer 22 is made of 2P resin, for example. The 2P resin is UV curable resin and fluorine UV curable resin is used, for example. The filled layer 2 needs to have a different refractive index from the lenticular lens sheet 1b. As shown in FIG. 13, if the second lens array 13 formed on the input surface of the lenticular lens sheet 1b is convex toward the input side, the refractive index of the filled layer 22 needs to be lower than that of the lenticular lens sheet 1b. On the contrary, if the second lens array 13 is concave toward the input side, the refractive index of the filled layer 22 needs to be higher than that of the lenticular lens sheet 1b.

On the output surface of the lenticular lens sheet 1b, the transparent sheet 18 and the functional layer 19 are formed. Since the transparent sheet 18 and the functional layer 19 are the same as in the first embodiment, the description is omitted.

As described in the foregoing, the rear projection screen of the ninth embodiment of the invention has the filled layer 22 between the lenticular lens sheet 1a having the first lens array 12 and the lenticular lens sheet 1b having the second lens array 13 and the self-aligned ambient light absorbing layer 17 on the output surface of the lenticular lens sheet 1b, and forms a solid structure from the first lens array 12 to the self-aligned ambient light absorbing layer 17 with light transmitting material. Therefore, the self-aligned ambient light absorbing layer 17 can be formed accurately in the positional relationship with the lens arrays 12 and 13. Particularly, since this embodiment allows the self-aligned ambient light absorbing layer 17 to be formed accurately in such a way that the focus positions of the first lens array 12 and the second lens array 13 are located in the vicinity of the position of the self-aligned ambient light absorbing layer 17, the contrast performance can be improved.

Though the self-aligned ambient light absorbing layer 17 is lattice-shaped in this example, it is not limited thereto, and it may be stripe-shaped. Further, the lenticular lens 11 may be formed on the output surface of the lenticular lens sheet 1a.

A method of manufacturing the rear projection screen according to the ninth embodiment of the invention is described below.

First, the lenticular lens sheets 1a and 1b are produced. For example, a base resin of the lens sheet is melt extruded with a T-die and both sides of cylindrical lenses are molded at the same time with a shaping roller. It is also possible to perform melt extrusion of the base with a T-die, mold a cylindrical lens in the input surface side with a shaping roller, and form a cylindrical lens in the output side with 2P by using a different mold. Alternatively, a base resin may be press-molded with a top and bottom two-side mold. The base resin and manufacturing method of the lenticular lens sheets 1a and 1b may be the same or different.

Then, 2P resin with a different refractive index from the base resin of the lenticular lens sheet 1b is filled on the output surface of the lenticular lens sheet 1a, thereby forming the filled layer 22.

Further, the lenticular lens sheet 1b is placed on the filled layer 22. Then, UV light is applied to the filled layer 22 to cure the filled layer 22.

After that, a film coated with light-shielding 2P resin is adhered to the top surface of the filled layer 22, and the self-aligned ambient light absorbing layer 17 is formed in the process described in the first embodiment.

Further, a transparent sheet 18 having substantially the same refractive index as the lenticular lens sheet 1 is laminated on the self-aligned ambient light absorbing layer 17. The lamination is made by adhesion with low refractive index 2P resin or with low refractive index adhesive material.

Furthermore, the functional film 19 is laminated on the surface of the transparent sheet 18. Specifically, the functional film 19 is directly coated on the transparent sheet 18 or a film coated with the functional film 19 is laminated.

This manufacturing method produces the rear projection screen having the structure shown in FIG. 13.

### EMBODIMENT 10

FIG. 14 shows a section of a rear projection screen according to a tenth embodiment of the invention. The rear projection screen of the tenth embodiment has basically the same structure as the rear projection screen of the ninth embodiment and different from it only in that a transparent sheet 23 is further placed on the output surface of the lenticular lens sheet 1b and the self-aligned ambient light absorbing layer 17 is formed on the output surface of the transparent sheet 23. This structure has the same effect as in the ninth embodiment. A method of manufacturing the rear projection screen of the tenth embodiment is the same as that of the ninth embodiment and the description is omitted.

### Other Embodiment

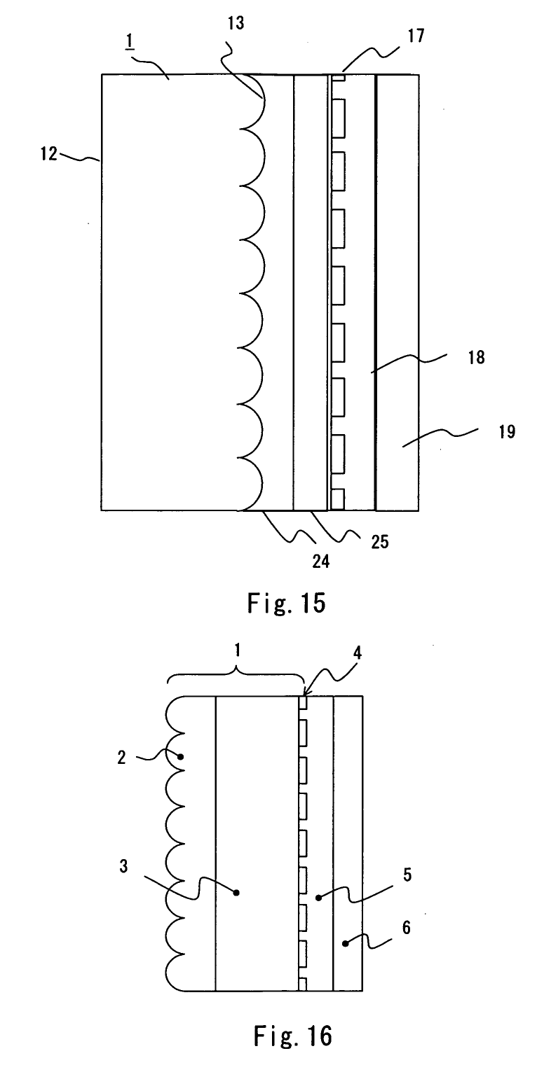

As shown in a sectional view of FIG. 15, the filled layer may be composed of two or more filled layers 24, 25.

Though the lenticular lens sheet 1 of the above embodiment has a one-sheet structure, it may be configured by forming lens arrays 12 and 13 respectively in two sheets and adhering the two.

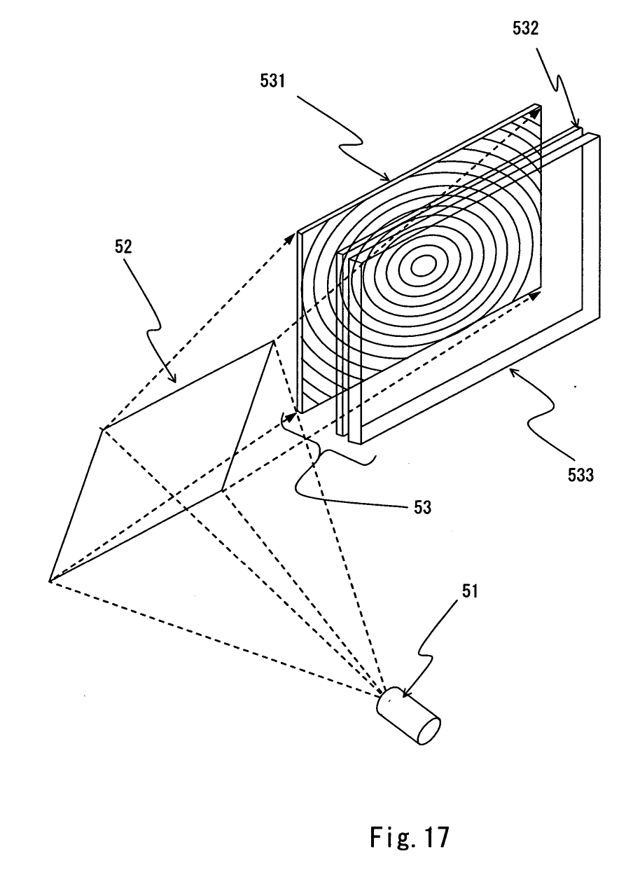

The lenticular lens sheet of the present invention is used, for example, in rear projection apparatus such as rear projection televisions and monitors. FIG. 17 shows a configuration example of the rear projection apparatus. Video light generated in and output from a rear projection projector 51 is reflected by a mirror 52 and input to a rear projection screen 53. The rear projection screen 53 is composed of a Fresnel lens sheet 531, a lenticular lens sheet 532, and a front plate 533. The light input to the rear projection screen 53 is narrowed down to a certain angle range by the Fresnel lens sheet 531 and input to the lenticular lens sheet 532. The light is diffused in the lenticular lens sheet 532 and output from the output surface through the front plate 533. An observer observes the light output from the front plate 533.

### EXAMPLE

Lens design is performed in the lenticular lens sheet according to each of the above embodiments of the invention.

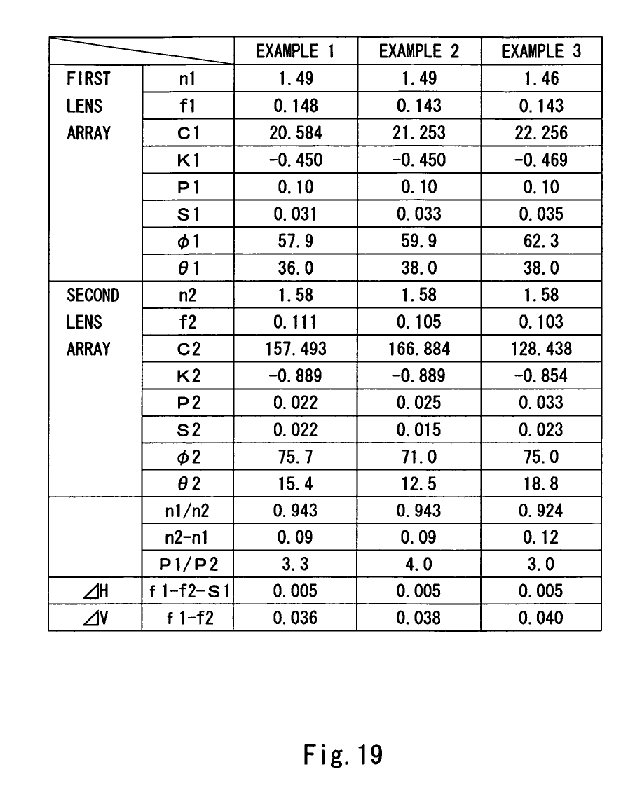

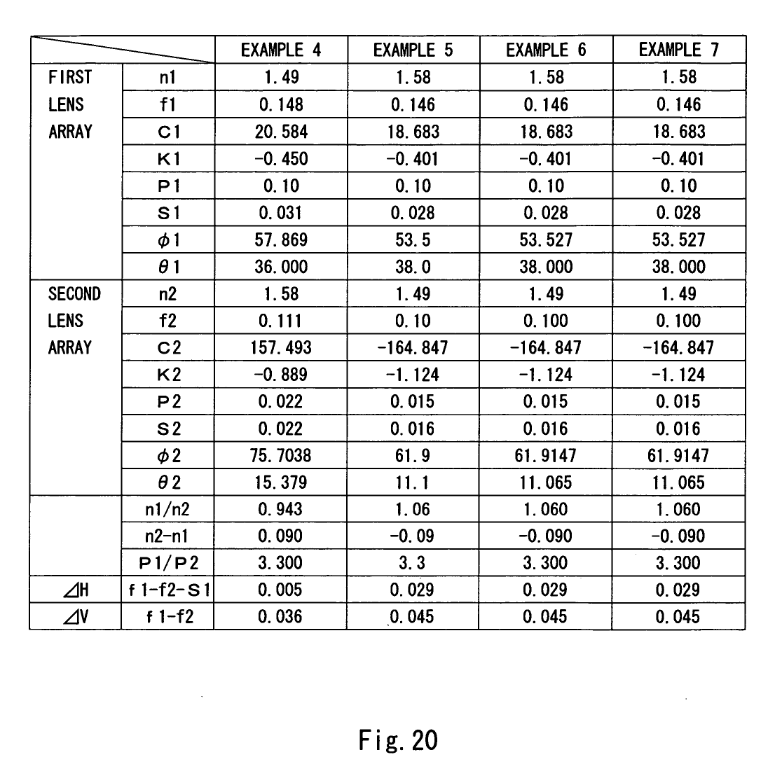

FIGS. 19 and 20 show a specific combination of refractive indexes of lens unit elements and the size measurement of a lens shape regarding examples 1 to 7. Examples 1, 2, and 3 correspond to the first embodiment, example 4 to the fourth embodiment, example 5 to the fifth embodiment, example 6 to the sixth embodiment, and example 7 to the seventh embodiment.

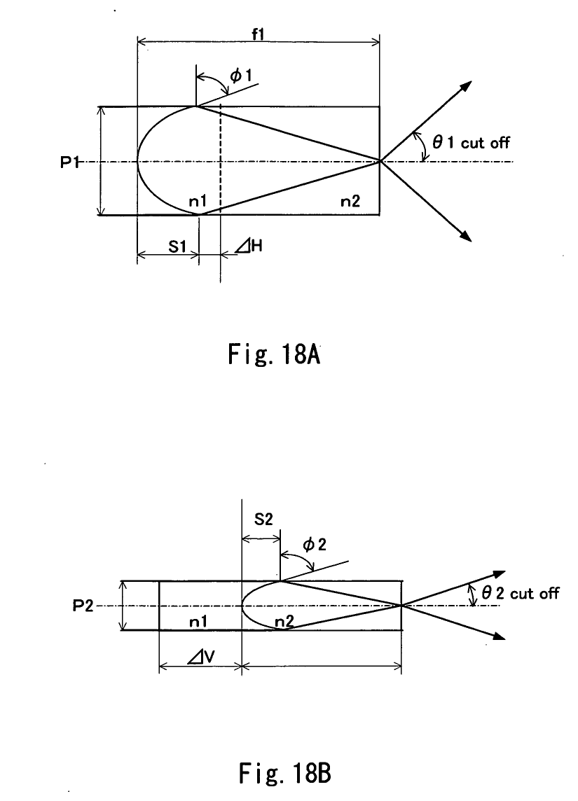

In order to describe each symbol in FIGS. 19 and 20, FIG. 18A shows a long sectional view of a lens unit element and FIG. 18B shows a cross sectional view of the same. In FIGS. 18 to 20, 1 is a suffix indicating a region of a first lens array, 2 is a suffix indicating a region of a second lens array, n indicates a refractive index of an output side material of a lens array, f indicates a focal length [mm] of a lens with respect to parallel incident light, C indicates a curvature of a lens, K indicates a conical constant of a lens, P indicates a pitch. [mm] of a lens, and S indicates a depth (SAG) [mm] of a lens. S indicates a maximum depth when a value of a distance X from a lens top point is X=±P/2 in the following formula:

$$S ( X ) = \frac{{CX}^{2}}{1 + \sqrt{1 - {C}^{2} ( K + 1 ) {X}^{2}}} + {A}_{2} {X}^{2} + {A}_{4} {X}^{4} + {A}_{6} {X}^{6} + {A}_{8} {X}^{8} + {A}_{10} {X}^{10}$$

where A₂ to A₁₀=0.

Further, φ indicates a tangent angle [deg] of a lens valley portion, θ indicates a lens refraction angle (cut-off angle of output light) [deg], ΔH indicates a distance [mm] between a first lens array valley portion and a second lens array valley portion, and ΔV indicates a distance [mm] between a first lens array top point and a second lens array top point.

In the examples 1 and 2, the first lens layer is formed of acrylic UV curable resin and the second lens layer is formed of MS resin. In the example 3, calculator simulation is performed assuming that the first lens layer is formed of fluoride UV curable resin and the second lens layer is formed of MS resin.

In the examples 4, 5, and 6, the first lens layer and the second lens layer are both formed of acrylic UV curable resin. In the example 7, the first lens layer is formed of MS resin and the second lens layer is formed of acrylic UV curable resin.

### INDUSTRIAL APPLICABILITY

The lenticular lens sheet according to the present invention is applied to a rear projection television, for example.

1. A lenticular lens sheet comprising:
a first lens array formed in an input surface;
a second lens array formed closer to a light output side than the first lens array, substantially orthogonal to the first lens array, and constituting an input side and an output side of a lens boundary with light transmitting material having different refractive index from each other; and
a self-aligned ambient light absorbing layer placed in a non-passing position of light having passed through the first lens array and the second lens array,
wherein a part from the first lens array to the self-aligned ambient light absorbing layer is a solid structure with light transmitting material.

2. The lenticular lens sheet of claim 1, wherein a light transmittance front plate is laminated in an output side of the self-aligned ambient light absorbing layer.

3. The lenticular lens sheet of claim 1, wherein the second lens array is composed of a plurality of lenses concave toward an input side, and the light transmitting material in the output side of the lens boundary of the second lens array has a lower refractive index than the light transmitting material in the input side.

4. The lenticular lens sheet of claim 1, wherein the second lens array is composed of a plurality of lenses convex toward an input side, and the light transmitting material in the output side of the lens boundary of the second lens array has a higher refractive index than the light transmitting material in the input side.

5. The lenticular lens sheet of claim 1, wherein a lens pitch of the first lens array is two to ten times a lens pitch of the second lens array.

6. The lenticular lens sheet of claim 1, wherein the self-aligned ambient light absorbing layer is lattice-shaped.

7. The lenticular lens sheet of claim 1, wherein the self-aligned ambient light absorbing layer is stripe-shaped.

8. A rear projection screen comprising:
a Fresnel lens sheet narrowing down light output from a rear projection projector into a certain angle range;
a lenticular lens sheet of claim 1; and
a front plate placed in an output surface side of the lenticular lens sheet.

9. A rear projection apparatus comprising:
a rear projection projector generating and outputting video light; and
a rear projection screen of claim 8 inputting the video light output from the rear projection projector.

10. A lenticular lens sheet comprising:
a first lens layer having a first lens array in an input surface;
a second lens layer having a second lens array substantially orthogonal to the first lens array in an output side boundary of the first lens layer and having a different refractive index from the first lens layer; and
a self-aligned ambient light absorbing layer placed on an output surface of the second lens layer and in a non-passing position of light having passed through the first lens layer and the second lens layer.

11. A lenticular lens sheet comprising:
a first lens layer having a first lens array;
a second lens layer having a second lens array substantially orthogonal to the first lens array;
a filled layer filled between the first lens layer and the second lens layer and having a different refractive index from at least the second lens layer; and
a self-aligned ambient light absorbing layer placed in a non-passing position of light having passed through the first lens array and the second lens array.

12. A method of manufacturing a lenticular lens sheet including a first lens layer having a first lens array in an input surface, a second lens layer having a second lens array substantially orthogonal to the first lens array in an output side boundary of the first lens layer and having a different refractive index from the first lens layer, and a self-aligned ambient light absorbing layer on an output surface of the second lens layer and in a non-passing position of light having passed through the first lens layer and the second lens layer, the method comprising:
a step of forming the second lens layer; and
a step of forming the first lens layer on the second lens layer after forming the second lens layer.

13. The method of manufacturing a lenticular lens sheet of claim 12, further comprising a step of forming the self-aligned ambient light absorbing layer, wherein the step of forming the self-aligned ambient light absorbing layer comprises a step of forming a photosensitive material layer in a light output surface side of the lenticular lens sheet; and a step of applying light from an input surface side of the lenticular lens sheet and forming a photosensitive part and a non-photosensitive part corresponding to a lens pattern on the photosensitive material layer, and a light-shielding pattern corresponding to the non-photosensitive part serves as the self-aligned ambient light absorbing layer.

14. The method of manufacturing a lenticular lens sheet of claim 13, wherein the photosensitive material layer is a photosensitive adhesive layer.

15. The method of manufacturing a lenticular lens sheet of claim 13, wherein
the photosensitive material layer is a photocurable composition layer composed of a first composition and a second composition having a lower surface free energy than the first composition, and
the method comprises:
a step of applying light to the photocurable composition layer from an input surface side of the lenticular lens sheet in a state where the photocurable composition layer is in contact with a medium with a lower surface free energy than the second composition to cure the photocurable composition layer located in a focus part of the lenticular lens pattern,
a step of applying light to the photocurable composition layer from a side of the photocurable composition layer in a state where the photocurable composition layer is in contact with a medium with a higher surface free energy than the first composition to cure the photocurable composition layer located in a non-focus part different from the focus-part, and
a step of placing coloring material on the photocurable composition layer and forming a light-shielding pattern corresponding to the non-focus part.

16. A method of manufacturing a lenticular lens sheet including a first lens layer having a first lens array in an input surface, a second lens layer having a second lens array substantially orthogonal to the first lens array in an output side boundary of the first lens layer and having a different refractive index from the first lens layer, and a self-aligned ambient light absorbing layer on an output surface of the second lens layer and in a non-passing position of light having passed through the first lens layer and the second lens layer, the method comprising:
a step of forming shapes corresponding to the first lens array and the second lens array on the first lens layer; and
a step of forming the second lens layer on the first lens layer.

17. The method of manufacturing a lenticular lens sheet of claim 16, wherein
the step of forming shapes corresponding to the first lens array and the second lens array on the first lens layer comprises:
a step of forming the first lens array in the first lens layer, and a step of forming the second lens array in the first lens layer.

18. The method of manufacturing a lenticular lens sheet of claim 16, further comprising a step of forming the self-aligned ambient light absorbing layer, wherein the step of forming the self-aligned ambient light absorbing layer comprises a step of forming a photosensitive material layer in a light output surface side of the lenticular lens sheet; and a step of applying light from an input surface side of the lenticular lens sheet and forming a photosensitive part and a non-photosensitive part corresponding to a lens pattern on the photosensitive material layer, and a light-shielding pattern corresponding to the non-photosensitive part serves as the self-aligned ambient light absorbing layer.

19. The method of manufacturing a lenticular lens sheet of claim 18, wherein the photosensitive material layer is a photosensitive adhesive layer.

20. The method of manufacturing a lenticular lens sheet of claim 18, wherein
the photosensitive material layer is a photocurable composition layer composed of a first composition and a second composition having a lower surface free energy than the first composition, and
the method comprises:
a step of applying light to the photocurable composition layer from an input surface side of the lenticular lens sheet in a state where the photocurable composition layer is in contact with a medium with a lower surface free energy than the second composition to cure the photocurable composition layer located in a focus part of the lenticular lens pattern,
a step of applying light to the photocurable composition layer from a side of the photocurable composition layer in a state where the photocurable composition layer is in contact with a medium with a higher surface free energy than the first composition to cure the photocurable composition layer located in a non-focus part different from the focus-part, and
a step of placing coloring material on the photocurable composition layer and forming a light-shielding pattern corresponding to the non-focus part.

21. A method of manufacturing a lenticular lens sheet, comprising:
a step of forming a first lens layer having a first lens array;
a step of forming a second lens layer having a second lens array substantially orthogonal to the first lens array;
a step of forming a filled layer having a different refractive index from the first lens layer between the first lens layer and the second lens layer; and
a step of forming a self-aligned ambient light absorbing layer in a non-passing position of light having passed through the first lens layer and the second lens layer.
